(19) United States
(12) Patent Application Publication
(10) Pub. No.: US 2021/0357438 A1
(43) Pub. Date: Nov. 18, 2021

(54) COMPUTER-READABLE RECORDING MEDIUM, INDEX CREATION DEVICE, INDEX CREATION METHOD, COMPUTER-READABLE RECORDING MEDIUM, SEARCH DEVICE, AND SEARCH METHOD

(71) Applicant: FUJITSU LIMITED, Kawasaki-shi (JP)

(72) Inventors: Masahiro KATAOKA, Kamakura (JP); Kosuke TAO, Kawasaki (JP); Kouzo NAGANO, Minato (JP)

(73) Assignee: FUJITSU LIMITED, Kawasaki-shi (JP)

(21) Appl. No.: 17/388,181

(22) Filed: Jul. 29, 2021

Related U.S. Application Data
(62) Division of application No. 15/709,772, filed on Sep. 20, 2017.

(30) Foreign Application Priority Data
Oct. 6, 2016 (JP) 2016-198486

(51) Int. Cl. G06F 16/31; G06F 16/33

(52) U.S. Cl. CPC G06F 16/316; G06F 16/334

(57) ABSTRACT

An index creation device reads target text data therein and creates a bitmap index in which, with regard to each of a character or a word and a tag that appear in the target text data, an appearance position of each of the character or the word and the tag in text data is represented as bitmap data.

### CROSS-REFERENCE TO RELATED APPLICATION(S)

This application is a Divisional of U.S. application Ser. No. 15/709,772, filed Sep. 20, 2017, and claims the benefit of priority of the prior Japanese Patent Application No. 2016-198486, filed on Oct. 6, 2016, the entire contents of each are incorporated herein by reference.

### FIELD

The embodiment discussed herein is related to a computer-readable recording medium.

### BACKGROUND

There is a bitmap index in which, in order to achieve high-speed search of text data, existence or non-existence of each character included in the text data is indexed on a file-by-file basis (for example, see International Publication No. WO 2013/038527).

Further, there is a technique for searching a character string by using a bitmap index that is created for a character or an n-gram to indicate existence or non-existence of the character or the n-gram in a file or a block.

Meanwhile, there is an application in which a character string between specific tags or the like is searched, instead of performing simple search of a character string.

### SUMMARY

According to an aspect of an embodiment, a non-transitory computer-readable recording medium has stored therein an index creation program. The index creation program causes a computer to execute a process. The process includes reading target text data into the computer. The process includes creating index information in which, with regard to each of a character or a word and a tag that appear in the target text data, an appearance position of the each of the character or the word and the tag in the text data is represented as bitmap data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a flow of a bitmap-index creating process according to an embodiment;

FIG. 2 is a diagram illustrating an example of a flow of a searching process according to the embodiment;

FIG. 3 is a functional block diagram illustrating a configuration example of an index creation device according to the embodiment;

FIG. 4 is a diagram illustrating an example of a flowchart of the index creating process according to the embodiment;

FIG. 5 is a functional block diagram illustrating a configuration example of a search device according to the embodiment;

FIG. 6 is a diagram illustrating an example of a flowchart of the searching process according to the embodiment;

FIG. 7 is a diagram illustrating an example of a flowchart of a word-string searching process according to the embodiment;

FIG. 8 is a diagram illustrating an example of a flowchart of a tag-condition searching process according to the embodiment;

FIG. 9 is a diagram illustrating an example of a hardware configuration of a computer;

FIG. 10 is a diagram illustrating a configuration example of a program that operates in a computer; and

FIG. 11 is a diagram illustrating a configuration example of a device in a system according to the embodiment.

### DESCRIPTION OF EMBODIMENT(S)

The conventional technique has a problem that it is not possible to search a character or a word string between specific tags at a high speed.

That is, when a bitmap index created for a character or an n-gram is used, it can be found that a character string to be searched exists in a specific file or block. However, it is not possible to determine whether a hit character string to be searched is the character or the word string between the specific tags included in a search condition, unless the specific file or block including the hit character string to be searched is read and collated. Therefore, it is not possible to search the character or the word string between the specific tags or the like at a high speed.

Preferred embodiments of the present invention will be explained with reference to accompanying drawings. The present invention is not limited to the embodiments.

### Example of Bitmap-Index Creating Process According to Embodiment

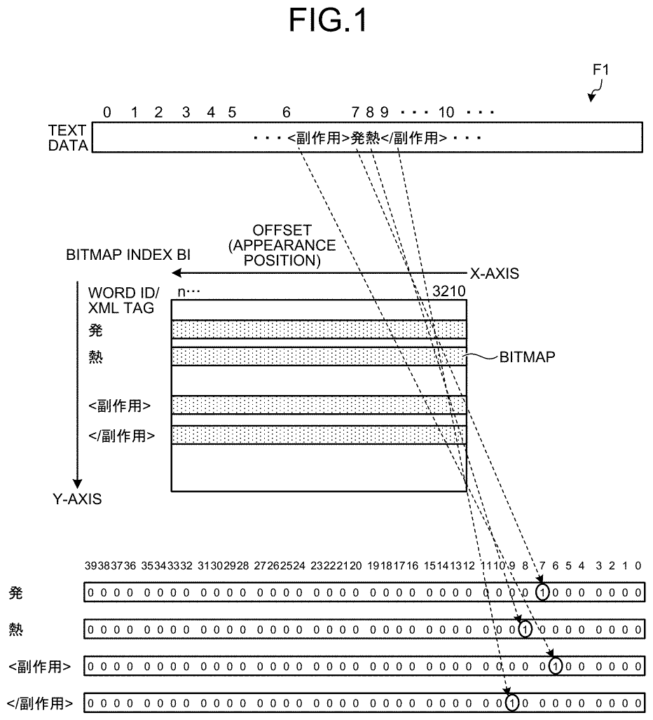

FIG. 1 is a diagram illustrating an example of a flow of a bitmap-index creating process according to an embodiment. As illustrated in FIG. 1, text data F1 is a document that includes both a tag and a character or a word string in a descriptive part other than the tag at the same time. The bitmap-index creating process creates a bitmap index in which with regard to each of a character or a word and a tag that appear in text data, an appearance position is represented as a bitmap. The character described here is a CJK character. The word described here is an English word. In the following descriptions, the bitmap-index creating process is referred to as “index creating process”.

The tag described here means a character string that starts with a start symbol ‘<’ and ends with an end symbol ‘>’. For example, the text data F1 includes data “< [symbol] > [symbol] </ [symbol] >”. In the data, < [symbol] > and < [symbol] > are the tags. < [symbol] > is a start tag, and < [symbol] > is an end tag. In the data, “ [symbol] ” corresponds to the character or the word string in the descriptive part other than the tag.

An index creation device reads out the text data F1 from a memory region and performs lexical analysis on the read text data F1. The lexical analysis described here is to divide the text data F1 into words, tags, and the like. In a Japanese text, a Chinese text, or the like, division may be performed not only in units of words but also in units of characters, such as Kana or Kanji.

The index creation device creates a bitmap index BI in which with regard to each of a character or a word and a tag that have been subjected to lexical analysis, an appearance position in the text data F1 is represented as a bitmap. For example, with regard to each of the character or the word and the tag that have been subjected to lexical analysis, the index creation device sets an appearance bit corresponding to an appearance position in the text data F1, in a bitmap corresponding to each of the character or the word and the tag in an appearing order of the character or the word and the tag.

The bitmap index BI is described. The bitmap index BI is a bit string in which a pointer specifying a character, a word, or a tag included in the text data F1 being a target is concatenated to a bit that indicates existence or non-existence of the character, the word, or the tag at an offset (appearance position) in the text data F1. That is, the bitmap index BI is a bitmap obtained by indexing existence or non-existence of a character, a word, or a tag included in the target text data F1 at each offset (appearance position). For example, in a case where a character, a word, or a tag exists at a certain appearance position in the text data F1, an appearance bit indicating ON, that is, “1” of a binary number is set as existence or non-existence at an offset (appearance position) corresponding to the appearance position. In a case where a character, a word, or a tag does not exist at a certain appearance position in the text data F1, an appearance bit indicating OFF, that is, “0” of a binary number is set as existence or non-existence at an offset (appearance position) corresponding to the appearance position. As the pointer specifying a character, a word, or a tag, an ID of the character, the word, or the tag (referred to as “word ID”) is employed, for example. The word ID may be the character, the word, or the tag itself, or may be any sign, for example, a compression code of the character, the word, or the tag. In the present embodiment, the description is made assuming that the word ID is the character, the word, or the tag itself.

For example, as illustrated in FIG. 1, an X-axis of the bitmap index BI represents an offset (appearance position) and a Y-axis represents a word ID. That is, each bitmap included in the bitmap index BI represents existence or non-existence of a character, a word, or a tag indicated by each word ID at each offset (appearance position). The description is made assuming that n is 39.

Here, a process in a case where the index creation device creates the bitmap index BI for the text data F1 is described. In the text data F1, “ ⋅ ⋅ ⋅ < [symbol] > [symbol] < [symbol] > ⋅ ⋅ ⋅ ” is stored.

The index creation device performs lexical analysis for the text data F1 to acquire “< [symbol] >”, “ [symbol] ”, “ [symbol] ”, and “< [symbol] >”.

With regard to a tag “< [symbol] >”, the index creation device sets an appearance bit corresponding to an appearance position in the text data F1, in a bitmap corresponding to the tag “< [symbol] >”. In this example, the tag “< [symbol] >” appears at a 6th position of the text data F1. Therefore, the index creation device sets an appearance bit indicating ON, that is, “1” of a binary number at a 6th bit as the appearance position in the bitmap corresponding to the tag “< [symbol] >”.

Subsequently, with regard to a character “ [symbol] ” the index creation device sets an appearance bit corresponding to an appearance position in the text data F1, in a bitmap corresponding to the character “ [symbol] ”. In this example, the character “ [symbol] ” appears at a 7th position of the text data F1. Therefore, the index creation device sets an appearance bit indicating ON, that is, “1” of a binary number at a 7th bit as the appearance position in the bitmap corresponding to the character “ [symbol] ”.

Subsequently, with regard to a character “ [symbol] ”, the index creation device sets an appearance bit corresponding to an appearance position in the text data F1, in a bitmap corresponding to the character “ [symbol] ”. In this example, the character “ [symbol] ” appears at an 8th position of the text data F1. Therefore, the index creation device sets an appearance bit indicating ON, that is, “1” of a binary number at an 8th bit as the appearance position in the bitmap corresponding to the character “ [symbol] ”.

Subsequently, with regard to a tag “< [symbol] >”, the index creation device sets an appearance bit corresponding to an appearance position in the text data F1, in a bitmap corresponding to the tag “< [symbol] >”. In this example, the tag “< [symbol] >” appears at a 9th position of the text data F1. Therefore, the index creation device sets an appearance bit indicating ON, that is, “1” of a binary number at a 9th bit as the appearance position in the bitmap corresponding to the tag “< [symbol] >”.

In this manner, the index creation device creates the bitmap index BI in which with regard to each of a character or a word and a tag that appear in the text data F1, an appearance position is represented as a bitmap.

### Example of Searching Process According to Embodiment

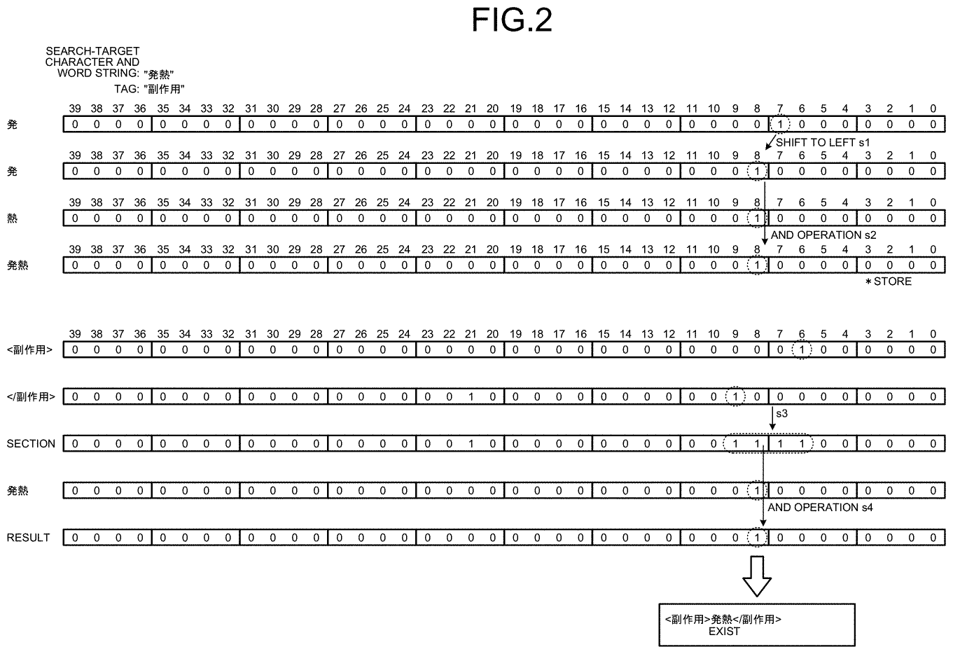

FIG. 2 is a diagram illustrating an example of a flow of a searching process according to the present embodiment. As illustrated in FIG. 2, the searching process determines whether a search-target character or word string exists in a descriptive part between search-target tags, based on the bitmap index BI. In the following descriptions of the searching process, it is assumed that the bitmap index BI of FIG. 1 is referred to.

A search device receives a search-target character or word string and a search-target tag. In this example, the search-target character or word string is “ [symbol] ” and the search-target tag is “ [symbol] ”.

The search device refers to the bitmap index BI to determine whether the search-target character or word string exists. For example, the search device shifts a bitmap corresponding to a preceding character or word included in the search-target character or word string by one bit to left (s1). In this example, the search device extracts a bitmap corresponding to a preceding character “ [symbol] ” included in the search-target character string “ [symbol] ” from the bitmap index BI. “1” is set at the 7th bit in this bitmap. The search device shifts this bitmap by one bit to left, so that “1” is set at the 8th bit in a resultant bitmap.

The search device then performs AND operation of the bitmap corresponding to the preceding character or word after being shifted and a bitmap corresponding to a succeeding character or word included in the search-target character or word string (s2). In this example, the search device extracts a bitmap corresponding to a succeeding character “ [symbol] ” included in the search-target character string “ [symbol] ”, from the bitmap index BI. “1” is set at the 8th bit in this bitmap. The search device performs AND operation of the bitmap corresponding to the preceding character “ [symbol] ” after being shifted and the bitmap corresponding to the succeeding character “ [symbol] ”. The search device then determines whether all bits are “0” as a result of the operation. In this example, it is determined that not all bits are “0” because the 8th bit of a resultant bitmap is calculated as “1”. That is, the search device determines that the search-target character string “ [symbol] ” exists in the text data F1.

The search device then refers to the bitmap index BI to determine whether the search-target character or word string exists in the descriptive part between the search-target tags. For example, the search device extracts a bitmap corresponding to each of a start tag “< [symbol] >” and an end tag “< [symbol] >” of the search-target tag. “1” is set at the 6th bit in the bitmap for the start tag “< [symbol] >”. “1” is set at the 9th bit in the bitmap for the end tag “< [symbol] >”. The search device detects a section of the tag “< [symbol] >”. (s3). In this example, a section between the 6th bit indicating an appearance position of the start tag “< [symbol] >” and the 9th bit indicating an appearance position of the end tag “< [symbol] >” is detected.

As an example of a method of detecting the section, it suffices that the search device shifts the bitmap for the end tag “< [symbol] >” by one bit to left and subtracts the bitmap for the start tag “< [symbol] >” from the shifted bitmap. Specifically, as a result of shifting the bitmap for the end tag “< [symbol] >” by one bit to left, a bit string from the 10th bit to the 6th bit is “10000”. A bit string from the 10th bit to the 6th bit for the start tag “< [symbol] >” is “00001”. The search device then subtracts the bit string for the start tag “< [symbol] >” from the bit string for the end tag “< [symbol] >”, to detect “01111” as a bit string from the 10th bit to the 6th bit. That is, a bit string from the 9th bit to the 6th bit “1111” is detected as the section of the tag “< [symbol] >”.

Thereafter, the search device performs AND operation of a bitmap corresponding to the section of the tag “< [symbol] >” and the bitmap corresponding to the search-target character string “ [symbol] ” (s4). The search device then determines whether all bits are “0” as a result of the operation. In this example, it is determined that not all bits are “0” because the 8th bit of a resultant bitmap is calculated as “1”. That is, the search device determines that the search-target character string “ [symbol] ” exists in the descriptive part between the search-target tags “< [symbol] >” of the text data F1. The search device then outputs “< [symbol] > [symbol] < [symbol] > exist”.

### Configuration of Index Creation Device According to Embodiment

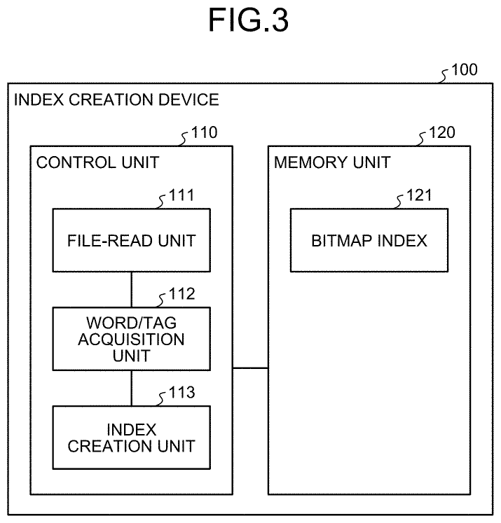

FIG. 3 is a functional block diagram illustrating a configuration example of the index creation device according to the present embodiment. As illustrated in FIG. 3, an index creation device 100 includes a control unit 110 and a memory unit 120.

The control unit 110 is a process unit that performs a process of creating the bitmap index BI illustrated in FIG. 1. The control unit 110 includes a file-read unit 111, a word/tag acquisition unit 112, and an index creation unit 113.

The memory unit 120 corresponds to a memory device, such as a non-volatile semiconductor memory element, for example, a flash memory or an FRAM® (Ferroelectric Random Access Memory). The memory unit 120 includes a bitmap index 121.

The bitmap index 121 is a set of bitmaps each obtained by indexing existence or non-existence of a character, a word, or a tag included in the text data F1 for each offset (appearance position). The bitmap index 121 corresponds to the bitmap index BI. The bitmap index 121 is identical to that of FIG. 1, and descriptions thereof are omitted.

The file-read unit 111 reads out a target file to a memory region.

The word/tag acquisition unit 112 reads out the text data F1 from the memory region, and performs lexical analysis for the read text data F1. The word/tag acquisition unit 112 sequentially acquires characters or words and tags after being subjected lexical analysis from the beginning of the text data F1. The word/tag acquisition unit 112 outputs the characters or the words and the tags that have been acquired and respective appearance positions thereof in the text data F1 to the index creation unit 113 to correspond to each other.

The index creation unit 113 creates the bitmap index 121. For example, with regard to a character or a word output from the word/tag acquisition unit 112, the index creation unit 113 extracts a bitmap corresponding to the character or the word from the bitmap index 121. The index creation unit 113 sets an appearance bit corresponding to an appearance position in the text data F1, in the extracted bitmap. With regard to a tag output from the word/tag acquisition unit 112, the index creation unit 113 extracts a bitmap corresponding to the tag from the bitmap index 121. The index creation unit 113 sets an appearance bit corresponding to an appearance position in the text data F1, in the extracted bitmap.

### Flowchart of Index Creating Process According to Embodiment

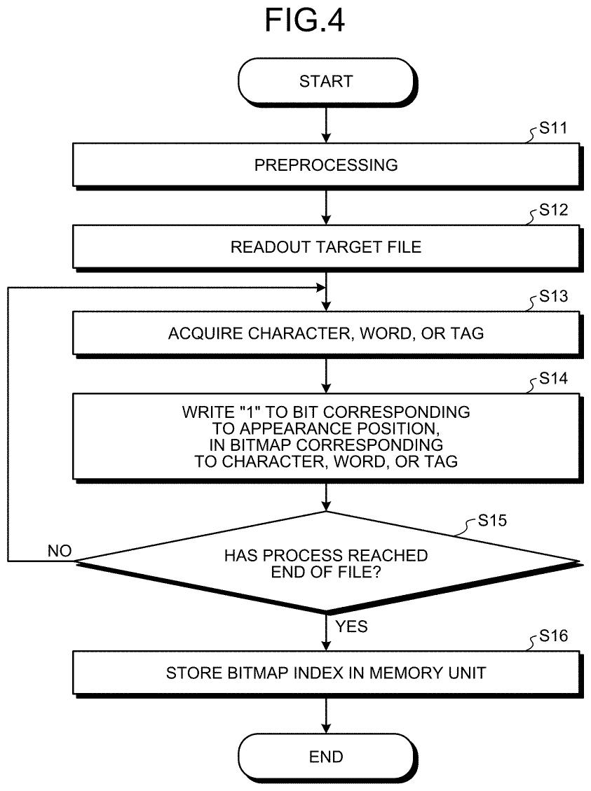

FIG. 4 is a diagram illustrating an example of a flowchart of the index creating process according to the present embodiment.

As illustrated in FIG. 4, the control unit 110 performs preprocessing (Step S11). For example, the control unit 110 reserves various types of memory regions in the memory unit 120. The control unit 110 then reads out a target file, and stores the text data F1 in a memory region for reading (Step S12).

The control unit 110 acquires characters, words, or tags from the beginning of the memory region for reading in turn (Step S13). For example, the control unit 110 performs lexical analysis for the text data F1 stored in the memory region for reading to sequentially acquire characters, words, or tags from the beginning.

The control unit 110 then writes “1” to a bit corresponding to an appearance position in each of bitmaps respectively corresponding to the characters, the words, or the tags that have been acquired (Step S14). In a case where an acquired object is a word, for example, the control unit 110 extracts a bitmap corresponding to that word from the bitmap index 121. The control unit 110 then sets an appearance bit corresponding to an appearance position of that word in the text data F1, in the extracted bitmap. In a case where an acquired object is a character, the control unit 110 extracts a bitmap corresponding to that character from the bitmap index 121. The control unit 110 then sets an appearance bit corresponding to an appearance position of that character in the text data F1, in the extracted bitmap. In a case where an acquired object is a tag, for example, the control unit 110 extracts a bitmap corresponding to that tag from the bitmap index 121. The control unit 110 then sets an appearance bit corresponding to an appearance position of that tag in the text data F1, in the extracted bitmap.

The control unit 110 then determines whether the process has reached the end of the file (Step S15). When determining that the process has not reached the end of the file (NO at Step S15), the control unit 110 proceeds to Step S13 to read out a next character, word, or tag.

Meanwhile, when determining that the process has reached the end of the file (YES at Step S15), the control unit 110 stores the bitmap index 121 in the memory unit 120 (Step S16). The control unit 110 then ends the index creating process.

### Configuration of Search Device According to Embodiment

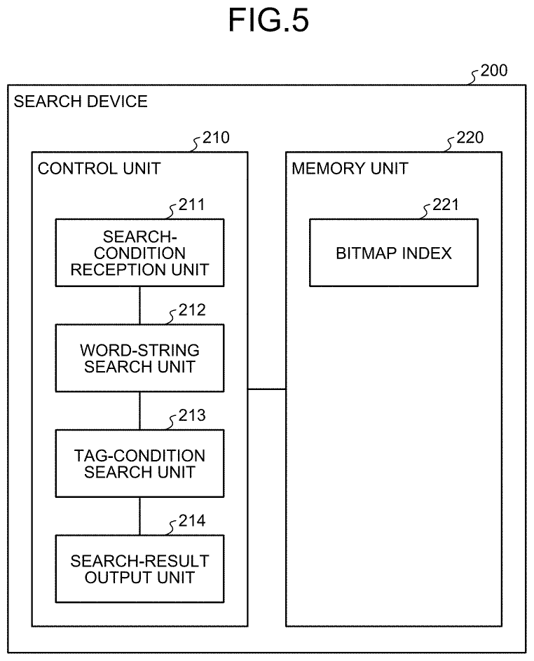

FIG. 5 is a functional block diagram illustrating a configuration example of the search device according to the present embodiment. As illustrated in FIG. 5, a search device 200 includes a control unit 210 and a memory unit 220.

The control unit 210 is a process unit that performs the searching process illustrated in FIG. 2. The control unit 210 includes a search-condition reception unit 211, a word-string search unit 212, a tag-condition search unit 213, and a search-result output unit 214.

The memory unit 220 corresponds to a memory device, such as a non-volatile semiconductor memory element, for example, a flash memory or an FRAM® (Ferroelectric Random Access Memory). The memory unit 220 includes a bitmap index 221.

The bitmap index 221 is identical to that of FIG. 1, and therefore descriptions thereof are omitted.

The search-condition reception unit 211 receives a search condition. For example, the search-condition reception unit 211 receives a search-target character or word string and a search-target tag as the search condition.

The word-string search unit 212 refers to the bitmap index 221 to determine whether the search-target character or word string exists in the text data F1. For example, the word-string search unit 212 extracts a bitmap corresponding to each character or each word that is included in the search-target character or word string from the bitmap index 221. The word-string search unit 212 shifts a bitmap corresponding to a preceding character or word by one bit to left. The word-string search unit 212 performs AND operation of the bitmap corresponding to the preceding character or word after being shifted and a bitmap corresponding to a succeeding character or word. The word-string search unit 212 determines whether all bits are “0” as a result of the operation. When not all bits are “0”, the word-string search unit 212 determines that a character or word string of the preceding character or word and the succeeding character or word exists. When there is an unprocessed character or word in the search-target character or word string, the word-string search unit 212 repeats the process of searching a character or word string that includes a current character or word string and a succeeding character or word. When there is no unprocessed character or word in the search-target character or word string, the word-string search unit 212 determines that the search-target character or word string exists. When all bits are “0”, the word-string search unit 212 determines that the character or word string of the preceding character or word and the succeeding character or word does not exist. That is, the word-string search unit 212 determines that the search-target character or word string does not exist.

The tag-condition search unit 213 refers to the bitmap index 221 to determine whether the search-target character or word string exists in a descriptive part between the search-target tags. For example, the tag-condition search unit 213 extracts a bitmap corresponding to each of a start tag and an end tag of the search-target tag from the bitmap index 221. The tag-condition search unit 213 creates a bitmap corresponding to a section of the search-target tag by using the bitmaps of the start tag and the end tag. The tag-condition search unit 213 then performs AND operation of the bitmap corresponding to the section of the search-target tag and a bitmap corresponding to the search-target character or word string. The tag-condition search unit 213 determines whether all bits are “0”. When not all bits are “0”, the tag-condition search unit 213 determines that the search-target character or word string exists in the descriptive part between the search-target tags. When all bits are “0”, the tag-condition search unit 213 determines that the search-target character or word string does not exist in the descriptive part between the search-target tags.

The search-result output unit 214 outputs a search result. For example, when it is determined by the tag-condition search unit 213 that the search-target character or word string exists in the descriptive part between the search-target tags, the search-result output unit 214 outputs that the search target exists, as the search result. When it is determined by the tag-condition search unit 213 that the search-target character or word string does not exist in the descriptive part between the search-target tags, the search-result output unit 214 outputs that the search target does not exist, as the search result.

### Flowchart of Searching Process According to Embodiment

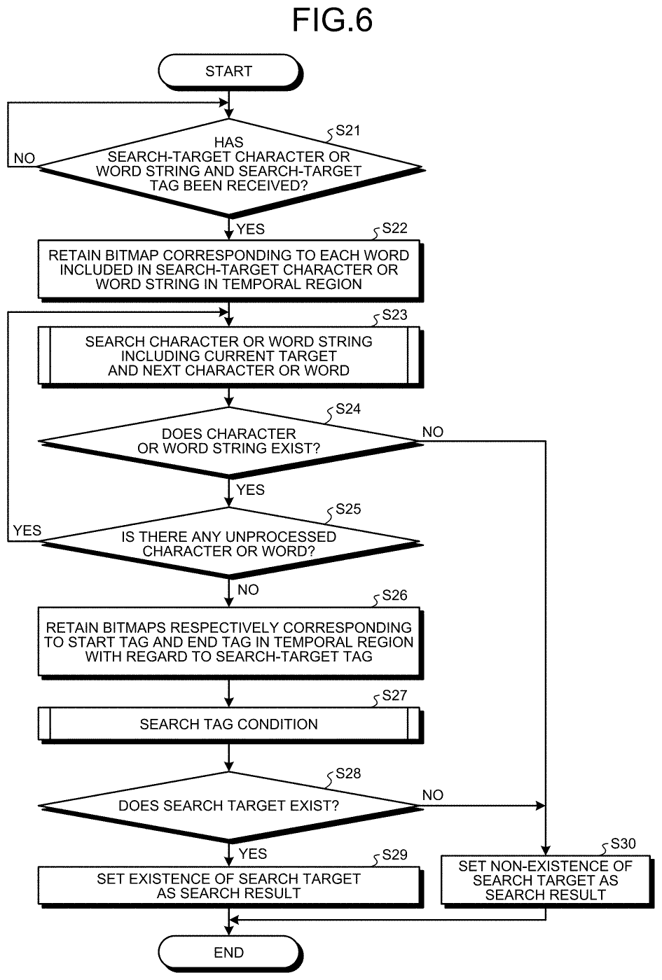

FIG. 6 is a diagram illustrating an example of a flowchart of the searching process according to the present embodiment.

As illustrated in FIG. 6, the control unit 210 determines whether a search-target character or word string and a search-target tag have been received (Step S21). When determining that the search-target character or word string and the search-target tag have not been received (NO at Step S21), the control unit 210 repeats the determining process until the search-target character or word string and the search-target tag are received.

Meanwhile, when determining that the search-target character or word string and the search-target tag have been received (YES at Step S21), the control unit 210 retains a bitmap corresponding to each character or each word included in the search-target character or word string in a temporal region (Step S22). For example, the control unit 210 extracts a bitmap corresponding to each character or each word included in the search-target character or word string from the bitmap index 221, and retains the extracted bitmap in a temporal memory region.

The control unit 210 performs a process of searching a character or a word string including a current target (a character or a word, or a character or a word string) and a next character or word (Step S23). A flowchart of the process of searching a word string will be described later.

As a result of the process of searching the character or the word string, the control unit 210 determines whether the character or the word string exists (Step S24). When determining that the character or the word string does not exist (NO at Step S24), the control unit 210 proceeds to Step S30.

Meanwhile, when determining that the character or the word string exists (YES at Step S24), the control unit 210 determines whether there is an unprocessed character or word in the search-target character or word string (Step S25). When determining that there is an unprocessed character or word in the search-target character or word string (YES at Step S25), the control unit 210 proceeds to Step S23 to search a character or a word string including a next character or word.

When determining that there is no unprocessed character or word in the search-target character or word string (NO at Step S25), the control unit 210 retains bitmaps respectively corresponding to a start tag and an end tag with regard to the search-target tag in a temporal region (Step S26). For example, the control unit 210 extracts bitmaps respectively corresponding to the start tag and the end tag in the search-target tag from the bitmap index 221, and retains each of the extracted bitmaps in a temporal memory region.

The control unit 210 searches a tag condition (Step S27). That is, the control unit 210 determines whether the search-target character or word string exists in a descriptive part between the search-target tags. A flowchart of a process of searching the tag condition will be described later.

The control unit 210 determines whether the search-target character or word string and the search-target tag exist as a result of the process of searching the tag condition (Step S28). When determining that the search-target character or word string and the search-target tag exist (YES at Step S28), the control unit 210 sets that the search target exists, as a search result (Step S29). Meanwhile, when determining that the search-target character or word string and the search-target tag do not exist (NO at Step S28), the control unit 210 proceeds to Step S30.

At Step S30, the control unit 210 sets that the search target does not exist, as the search result (Step S30). The control unit 210 then ends the searching process.

### Flowchart of Word-String Searching Process According to Embodiment

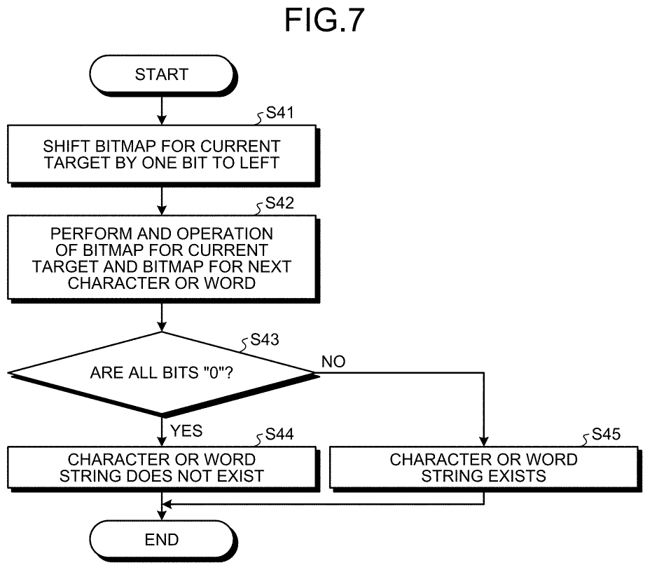

FIG. 7 is a diagram illustrating an example of a flowchart of the word-string searching process according to the present embodiment.

As illustrated in FIG. 7, the control unit 210 shifts a bitmap for a current target (a character or a word, or a character or a word string) by one bit to left (Step S41). The control unit 210 then performs AND operation of the bitmap for the current target and a bitmap for a next character or word (Step 342).

The control unit 210 determines whether all bits in a bitmap indicating a result of the AND operation are “0” (Step S43). When determining that all bits are “0” (YES at Step S43), the control unit 210 determines that a character or a word string including the current target and the next character or word does not exist in the text data F1 (Step S44). The control unit 210 then ends the word-string searching process.

Meanwhile, when determining that not all bits are “0” (NO at Step S43), the control unit 210 determines that the character or the word string including the current target and the next character or word exists in the text data F1 (Step S45). The control unit 210 then ends the word-string searching process.

### Flowchart of Tag-Condition Searching Process According to Embodiment

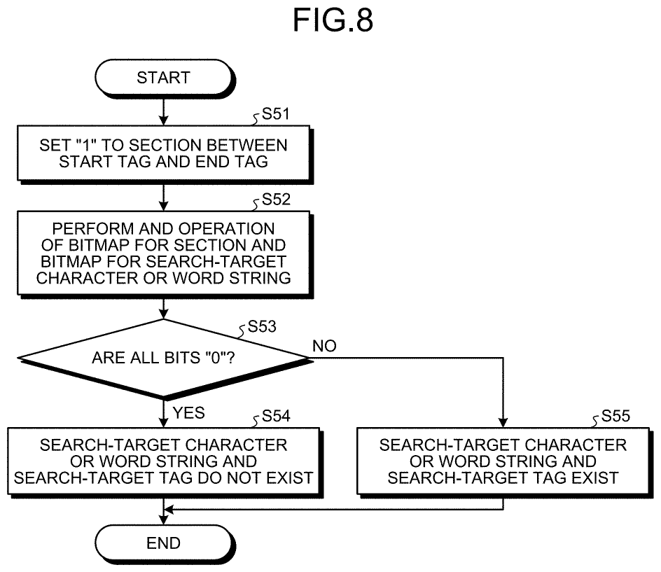

FIG. 8 is a diagram illustrating an example of a flowchart of a tag-condition searching process according to the present embodiment.

As illustrated in FIG. 8, the control unit 210 sets “1” to a section between a start tag and an end tag (Step S51). For example, the control unit 210 shifts a bitmap corresponding to the end tag by one bit to left, and subtracts a bitmap corresponding to the start tag from the shifted bitmap. The control unit 210 then performs AND operation of a bitmap corresponding to the section between the start tag and the end tag and a bitmap corresponding to a search-target character or word string (Step S52).

The control unit 210 determines whether all bits of a bitmap indicating a result of the AND operation are “0” (Step S53). When determining that all bits are “0” (YES at Step S53), the control unit 210 determines that the search-target character or word string and the search-target tag do not exist in the text data F1 (Step S54). That is, the control unit 210 determines that the search-target character or word string does not exist in a descriptive part between the search-target tags. The control unit 210 then ends the tag-condition searching process.

Meanwhile, when determining that not all bits are “0” (NO at Step S53), the control unit 210 determines that the search-target character or word string and the search-target tag exist in the text data F1 (Step S55). That is, the control unit 210 determines that the search-target character or word string exists in the descriptive part between the search-target tags. The control unit 210 then ends the tag-condition searching process.

### Effect of Embodiment

According to the above embodiment, the index creation device 100 reads the target text data F1 therein. The index creation device 100 creates the bitmap index 121 in which with regard to each of a character or a word and a tag that appear in the target text data F1, an appearance position of each of the character or the word and the tag in text data F1 is represented as bitmap data. With this configuration, the index creation device 100 can increase the speed of searching a tag and a character string to be searched that includes a character or a word by using the bitmap index 121. Further, the index creation device 100 can search existence or non-existence of the character string to be searched, existence or non-existence of a plurality of appearances of the character string to be searched, and the number of appearances of the character string to be searched only by referring to the bitmap index 121, without referring to the target text data F1.

Furthermore, according to the above embodiment, the search device 200 receives a search request including a predetermined character or word and a predetermined tag. The search device 200 determines whether the predetermined character or word is included in a tag section of the predetermined tag based on an appearance position of the tag included in the bitmap index 221. With this configuration, the search device 200 can perform high speed search with less search noise by using the bitmap index 221.

### Other Modes Related to Embodiment

A part of modifications in the embodiment described above is described below. The modifications in the embodiment are not limited to that described below, and design change can be made as appropriate without departing from the scope of the present invention.

Further, the index creation device 100 creates the bitmap index 121 in which with regard to each of a character or a word and a tag that appear in the text data F1, an appearance position is represented as a bitmap. However, the index creation device 100 is not limited thereto, but may create a hash index in which each bitmap is hashed from the bitmap index 121. With this configuration, the index creation device 100 can suppress the size of index information to be retained. In this case, it suffices that the search device 200 restores hash bitmaps respectively corresponding to a word or a character and a tag that are targets in the hash index and performs a searching process for the restored bitmaps.

The index creation device 100 creates the bitmap index 121 in which with regard to each of a character or a word and a tag that appear in the text data F1, an appearance position is represented as a bitmap. However, the index creation device 100 is not limited thereto, and may add tag-attribute information that indicates which tag each character or word belongs to, to the bitmap index 121 based on the appearance position of the tag included in the bitmap index 121. In this case, when receiving a search request including a predetermined character or word and a predetermined tag, the search device 200 determines by using the tag-attribute information added to the bitmap index 121 whether the respective predetermined character or word belongs to the predetermined tag. This enables the search device 200 to perform search at a higher speed with less search noise.

Information including process procedures, control procedures, specific names, and various types of data and parameters described in the above embodiment can be arbitrarily changed unless otherwise specified.

### Hardware Configuration

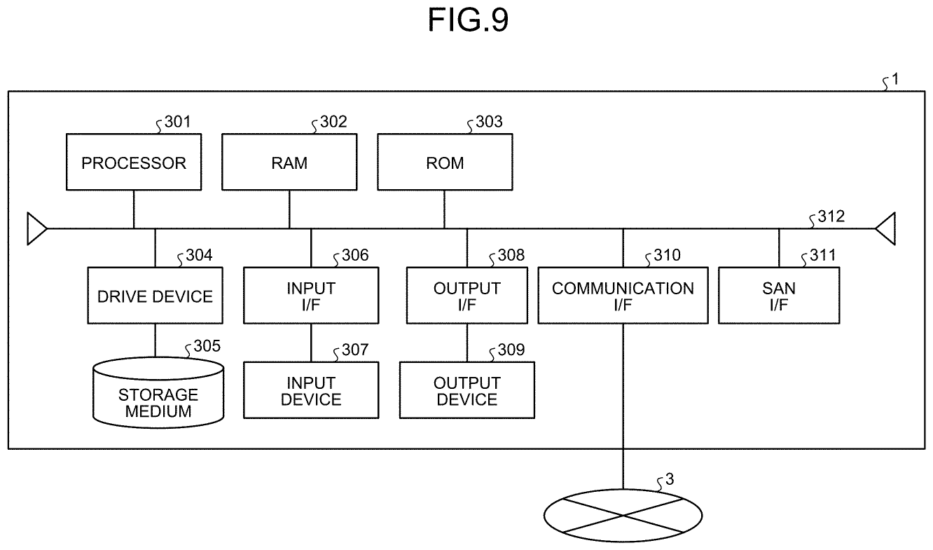

Hardware and software used in the above embodiment are described below. FIG. 9 is a diagram illustrating an example of a hardware configuration of a computer 1. The computer 1 includes a processor 301, a RAM (Random Access Memory) 302, a ROM (Read Only Memory) 303, a drive device 304, a storage medium 305, an input interface (I/F) 306, an input device 307, an output interface (I/F) 308, an output device 309, a communication interface (I/F) 310, an SAN (Storage Area Network) interface (I/F) 311, and a bus 312, for example. Respective hardware components are mutually connected via the bus 312.

The RAM 302 is a memory device that allows reading therefrom and writing thereto. For example, a semiconductor memory, such as an SRAM (Static RAM) or a DRAM (Dynamic RAM) or a flash memory that is not a RAM is used. The ROM 303 includes a PROM (Programmable ROM) or the like. The drive device 304 is a device that performs at least one of reading information recorded in the storage medium 305 and writing information. The storage medium 305 stores therein information written by the drive device 304. The storage medium 305 is a storage medium, for example, a hard disk, a flash memory such as an SSD (Solid State Drive), a CD (Compact Disk), a DVD (Digital Versatile Disc), or a Blu-ray disk. Further, the computer 1 is provided with the drive device 304 and the storage medium 305 for each of a plurality of types of storage media, for example.

The input interface 306 is a circuit that is connected to the input device 307 and transmits an input signal received from the input device 307 to the processor 301. The output interface 308 is a circuit that is connected to the output device 309 and causes the output device 309 to perform output in accordance with an instruction from the processor 301. The communication interface 310 is a circuit that controls communication via a network 3. The communication interface 310 is a network interface card (NIC), for example. The SAN interface 311 is a circuit that controls communication with a storage device connected to the computer 1 by a storage area network. The SAN interface 311 is a host bus adapter (HBA), for example.

The input device 307 is a device that transmits an input signal in accordance with an operation. The input signal is a signal from a key device, such as a keyboard or a button attached to the body of the computer 1, or a pointing device, such as a mouse or a touch panel. The output device 309 is a device that outputs information in accordance with control by the computer 1. For example, the output device 309 is an image output device (a display device) such as a display, and an audio output device, such as a speaker. An input/output device such as a touch screen is used as the input device 307 and the output device 309, for example. Further, the input device 307 and the output device 309 may be integrated with the computer 1, or they may be connected from an outside to the computer 1, for example.

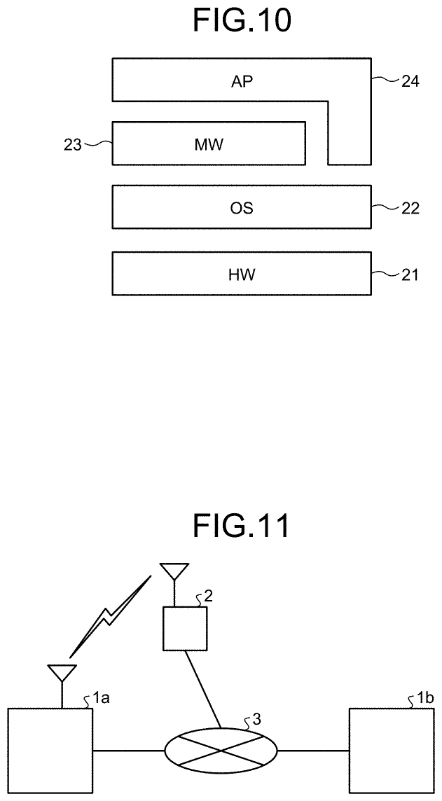

For example, the processor 301 reads out a program stored in the ROM 303 or the storage medium 305 to the RAM 302, and performs processing of the control unit 110, 210 in accordance with a procedure of the read program. In this processing, the RAM 302 is used as a work area of the processor 301. The ROM 303 and the storage medium 305 store therein a program file (for example, an application program 24, middleware 23, and an OS 22 described later) or a data file (for example, the bitmap index 121, 221), and the RAM 302 is used as the work area of the processor 301, so that a function of each of the memory units 120 and 220 is achieved. The program read out by the processor 301 is described with reference to FIG. 10.

FIG. 10 is a diagram illustrating a configuration example of a program that operates in a computer. The OS (operating system) 22 that controls a group of hardware components (HW) 21 (301 to 311) illustrated in FIG. 10 operates in the computer 1. The processor 301 operates in a procedure in accordance with the OS 22 to execute control and perform management for the HW 21, so that processing in accordance with the application program (AP) 24 or the middleware (MW) 23 is performed in the HW 21. Further, in the computer 1, the MW 23 or the AP 24 is read out to the RAM 302 and is executed by the processor 301.

By performing processing based on at least a portion of the MW 23 or the AP 24 by the processor 301 when an index creation function is called (the HW 21 is controlled based on the OS 22 by that processing), a function of the control unit 110 is achieved. By performing processing based on at least a portion of the MW 23 or the AP 24 by the processor 301 when a search function is called (the HW 21 is controlled based on the OS 22 by that processing), a function of the control unit 210 is achieved. The index creation function and the search function may be included in the AP 24 itself or may be a part of the MW 23 executed by being called in accordance with the AP 24.

FIG. 11 is a diagram illustrating a configuration example of a device in a system according to the present embodiment. The system of FIG. 11 includes a computer 1a, a computer 1b, a base station 2, and the network 3. The computer 1a is connected to the network 3 connected to the computer 1b in at least a wired or wireless manner.

The index creation device 100 and the search device 200 can be included in either the computer 1a or the computer 1b illustrated in FIG. 11. It is possible that the computer 1b includes the functions of the index creation device 100 and the computer 1a includes the functions of the search device 200, or the computer 1a includes the functions of the index creation device 100 and the computer 1b includes the functions of the search device 200. Further, it is possible that the computer 1a and the computer 1b both include the functions of the index creation device 100 and the functions of the search device 200.

According to an aspect, a character or a word string between specific tags or the like can be searched at a high speed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein an index creation program that causes a computer to execute a process comprising:
reading target text data into the computer; and
creating index information in which, with regard to each of a character or a word and a tag that appear in the target text data, an appearance position of the each of the character or the word and the tag in the text data is represented as bitmap data.

2. The non-transitory computer-readable recording medium according to claim 1, wherein the process of creating adds information indicating which tag each of the character or the word belongs to in the index information.

3. An index creation device comprising:
a processor;
a memory, wherein the processor executes a process comprising:
reading target text data therein; and
creating index information in which, with regard to each of a character or a word and a tag that appear in the target text data, an appearance position of the each of the character or the word and the tag in the text data is represented as bitmap data.

4. An index creation method to be executed by a computer, the method comprising:
reading target text data into the computer using a processor; and
creating index information in which, with regard to each of a character or a word and a tag that appear in the target text data, an appearance position of the each of the character or the word and the tag in the text data is represented as bitmap data using the processor.
